(19) United States
(12) Patent Application Publication
(10) Pub. No.: US 2006/0069914 A1
(43) Pub. Date: Mar. 30, 2006

(54) Mobile authentication for network access

(75) Inventors: Stephan Rupp, Besigheim (DE); Markus Jenisch, Waiblingen (DE)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 11/205,218

(22) Filed: Aug. 17, 2005

(30) Foreign Application Priority Data
Sep. 30, 2004 (EP) 04292341.7

(51) Int. Cl. H04L 9/00

(52) U.S. Cl. 713/168

(57) ABSTRACT

The present invention provides a method for authenticating a user to a network by means of a temporary and/or one-time password. The temporary and/or one-time password being provided by a service provider that can be accessed by means of a mobile telecommunication device. The temporary password is provided on demand, when the user invokes a corresponding access request that is transmitted to the service provider by means of the mobile telecommunication device. The service provider checks and asserts a received access request and generates the temporary password by making use of a dedicated cryptographic method. The generated temporary password is finally displayed to the user by means of the mobile telecommunication device and the user may then manually enter the temporary password into the computing device in order to authenticate to the network.

### FIELD OF THE INVENTION

The present invention relates to the field of authentication to networks, in particular without limitation to networks based on Internet protocol (IP).

The invention is based on a priority application, EP 04292341.7, which is hereby incorporated by reference.

### BACKGROUND AND PRIOR ART

The working environment for companies dealing with large amount of data is nowadays dominated by computers and in particular by networked computers.

These corporate networks provide an efficient communication platform for the staff of a company or other institutions, like universities. These corporate networks effectively allow to provide IT services to a well defined group of persons, as e.g. employees of a company. Corporate networks also provide a basis for establishing an Intranet that provides company specific data only to those computers that are physically connected to the corporate network. In this way, a corporate network effectively prevents external access to confidential company specific data or company specific IT services, such as e.g. company specific software. Consequently, an employee of a company can only access company specific data and IT services when the employee makes use of a computer that is physically embedded into the corporate network.

Due to the large expansion of the Internet, data and IT services principally became accessible worldwide. Moreover, due to an increasing mobility of members of a staff, it is therefore highly desirable also to provide access to corporate networks from computers that are located at remote locations and that may contact a corporate network via the Internet. In this way an employee could access the corporate network or Intranet from his home or from a hotel when on business travel. Worldwide access to corporate networks via the Internet is in principle realizable. However, Internet based communication is rather un-secure and typically does not meet the stringent security requirements of a corporate network.

Here, the concept of virtual private network (VPN) provides a general solution. A VPN is a private communications network that is typically used within a company or by several different companies or organisations that communicate over a public network. VPN message traffic is typically carried on public networking infrastructure, e.g. the Internet, using standard and hence possibly un-secure communication protocols, such as IPv4. Virtual private networks use cryptographic tunnelling protocols to provide the necessary confidentiality, sender authentication and message integrity to achieve the privacy intended. When properly chosen, implemented, and used, such techniques can indeed provide secure communications over un-secure networks.

Nowadays, there exists a plurality of different implementation schemes for establishing VPNs. There exists a plurality of different VPN protocols that for example include IP security (IPSEC) that is an obligatory part of IPv6, Point to Point Tunnelling Protocol (PPTP), Layer 2 Forwarding (L2F) and Layer 2 Tunnelling Protocol (L2TP).

For almost any VPN a secure authentication is required. For example, when an employee of a company wants to access the corporate network either from home or during business travel, the employee may typically make use of a portable computer and a dedicated authentication device, such as a Token. The mobile computer is typically provided with a dedicated authentication software, such like a VPN client. In order to authenticate the mobile computer to a VPN gateway of the corporate network, the user has to enter a one-time password into the mobile computer. Such a one-time or temporary password is generated by the Token that is implemented as hardware and carried along with the user. When handed over to the employee, the Token is typically synchronised with the VPN gateway of the corporate network in order to provide the one-time password to the employee.

This temporary and/or one-time password might be subject to modification after a predefined time interval has elapsed. For example, the password to be generated by the Token changes once a minute and is determined via a cryptographic function. Typically, the one-time password is graphically displayed on the Token. The employee can then enter the one-time password with his username in order to authenticate to the corporate network. Since, the combination of user name and one-time password is valid for a maximum of one minute, the authentication scheme making use of the one-time password provides a high level of security.

Tokens that are implemented as hardware devices for secure authentication to corporate networks are for example commercially available as RSA SecurID that are distributed by Secur Integration GmbH, 51107 Cologne, Germany; see also www.securintegration.de.

Even though the above described authentication scheme making use of one-time temporary passwords based on hardware Tokens provides a high level of security for establishing VPN IP-based connections, it is rather disadvantageous for the employee or user to carry along such a hardware implemented Token. In particular, when an employee or a private person requires remote access to a plurality of different corporate networks, for each one of these networks a dedicated hardware Token is required. This certainly limits the diversity and universality of the above described secure authentication scheme.

The present invention therefore aims to provide and to realize a secure authentication scheme that does not require to carry along a network specific piece of hardware, such as a Token.

### SUMMARY OF THE INVENTION

The present invention provides a method of authenticating a user to a network. The user makes use of a computing device that is adapted to establish an IP-based connection to the network, wherein authentication to the network requires entering at least a user identification and a temporary password. The inventive method of authenticating the user to the network comprises requesting the temporary password from a service provider by transmitting an access request to the service provider. This access request is transmitted by means of a mobile telecommunication device. Once received by the service provider, the access request is checked on the basis of a user authentication database. If the user is authorized to access the network, the corresponding access request will be asserted by the service provider and consequently the temporary password will be generated.

After generation of the temporary password by the service provider, the temporary password is transmitted from the service provider to the mobile telecommunication device. The user is then provided with the temporary, one-time password and is therefore enabled to authenticate to the network by entering his user identification and the corresponding one-time password.

In contrast to the prior art solution, where the user of the corporate network has to carry along a network specific hardware Token, the invention provides delivery of the one-time password to the user by making use of a mobile telecommunication device, such as a cellular phone. Hence, the user that wishes to authenticate to a network transmits a dedicated access request to a service provider. The service provider then provides the functionality of the former hardware Token and generates the network specific one-time password for the user. Typically, generation of the network specific one-time password is only performed by the service provider in response to an assertion of the user's identity and the user's authorization to the network.

The inventive method can be implemented into existing mobile communication networks by expanding the capabilities of a telecommunication provider. Hence, the telecommunication provider has to administrate a user authentication database providing information whether a specific user is authorized to access a distinct network. Moreover, the user authentication database may further specify various levels of authentication and various levels of access rights of a user of a network.

Checking of the access request and generating the temporary password not necessarily has to be provided by a telecommunication provider. Moreover, the inventive authentication service might be provided by any other provider. It must only be guaranteed, that the requested service, i.e. providing a temporary one-time password to the user, is accessible via a mobile phone.

In this way, a user is effectively enabled to authenticate and to establish a VPN connection to e.g. a corporate network without carrying along a network specific hardware Token. Hence, the entire functionality of a hardware Token as it is known in the prior art, is effectively replaced by installing a corresponding service by means of a service provider that is accessible via a mobile phone of the user. Advantageously, the user has no longer to carry along an additional hardware device that only serves to provide a temporary password for authenticating to a VPN network. In this way, a user may also authenticate to a plurality of different networks by making use of his mobile telecommunication device.

When transmitting the access request to the service provider, the user also specifies which one of a plurality of networks he wishes to access. Hence, the access request is therefore at least indicative of a user identification and a network the user wishes to access. Now, depending on the parameters provided by the access request, the service provider may generate the appropriate one-time password. In this way, the functionality of a plurality of hardware Tokens is merged by means of the service provider.

According to a further preferred embodiment of the invention, requesting of the temporary password from the service provider further comprises authenticating the user to the service provider. When for example the service provider is implemented as a mobile communication provider, for accessing services of the mobile communication provider the user has to make use of an appropriate card, like a subscriber identity module (SIM) card in combination with a corresponding personal identification number (PIN). Once being authorised to access the services of the telecommunication provider, requesting of the temporary password for authenticating to the VPN network may further require an additional authentication step that might be implemented by entering an additional PIN. In this way, an additional protection mechanism for receiving of the temporary password is effectively implemented.

Hardware Tokens that are known in the prior art may require entering of a PIN in order to receive a one-time password. Such a PIN request that activates generation of the temporary password can be implemented in an analogous way into the inventive method. Hence, the access request being transmitted to the service provider, further has to comprise a corresponding PIN that serves to authenticate the user of the mobile device to receive the temporary password.

This authentication method prohibiting misuse of the temporary password generating functionality of the service provider is typically implemented on top of the service provider's access scheme. This service providers access scheme typically consists of a combination of SIM card and SIM card specific PIN. In this way, for receiving the temporary one-time password from the service provider, the user has to enter a first PIN into the mobile telecommunication device in order to access the service provider. Then, in order to receive the temporary password, the service provider may require a second PIN for authorization of the user with respect to the VPN network. Preferably, these first and second PINs are implemented as static passwords that might be arbitrarily configured by the user.

According to a further preferred embodiment of the invention, the access request being transmitted to the service provider further comprises at least a network identifier and an identifier of the mobile telecommunication device. The identifier of the mobile telecommunication device is indicative of the user's identity. In the framework of mobile telecommunication, any communication partner is assigned with an individual number, such as e.g. a number of the cellular phone. By means of this mobile phone number, the user of the respective mobile phone can be identified. Assignment between a user and a phone number is typically realized by means of an identifier of the SIM card of the mobile phone. In this way, the user's identity is inherently resolved by transmitting the access request to the service provider.

Since the access request is further indicative of an identifier of the network, sufficient information for generating the temporary password is therefore given to the service provider. The user authorization database that is administered by the service provider provides required information whether a specific user is authorized to access a distinct network. In this way, the access request can be sufficiently checked on the basis of the user authentication database. The user authentication database therefore effectively allows to assert or to deny an access request and hence to enable or to disable generation and transmittance of a temporary password to the user.

According to a further preferred embodiment of the invention, the temporary password can also be transferred from the mobile telecommunication device to the computing device on the basis of a communication interface and a corresponding communication protocol. In this way, a temporary one-time password that is received by the mobile telecommunication device does not have to be explicitly read by the user and successively manually entered into the computing device by the user. By providing both the mobile telecommunication device and the computing device with a respective communication interface, the temporary one-time password can be automatically transferred from the mobile telecommunication device to the computing device in response to receive the temporary password from the service provider. In this way, the user may only have to confirm entering of the provided password.

Moreover, the entire authentication procedure might be realized in a single step that comprises requesting of the temporary password by making use of the mobile telecommunication device. In principle, when particularly desired, receiving of the one-time password, transmitting of the one-time password to the computing device as well as entering and confirming the password might be performed in an entirely autonomous way. In this case the user may only have to invoke the authentication procedure by selecting a one-time password request function on his mobile telecommunication device and entering the first and/or second PIN.

According to a further preferred embodiment of the invention, the network is implemented as an IP-based virtual private network. The VPN network comprises a VPN gateway and the computing device comprises a VPN client. Moreover, the computing device can be implemented as any arbitrary kind of computing device, such as a workstation being installed in a immobile way in an employee's home, a mobile laptop computer for accessing the corporate network from any location worldwide or as a personal digital assistant (PDA). Also, in a sophisticated embodiment, the functionality of the computing device and the mobile telecommunication device might be incorporated and merged in a single multifunctional device, such as cellular phones with integrated computing facilities providing web browsing, email service, text processing applications and the like.

In another aspect the invention provides a mobile telecommunication device for providing a temporary password to a user. This temporary password is required by the user in order to authenticate to a network. The mobile telecommunication device comprises means for transmitting an access request to a service provider, means for receiving the temporary password from the service provider, wherein the temporary password is generated by the service provider in response to an assertion of the access request. Furthermore, the inventive mobile telecommunication device comprises means for providing the temporary password to the user. Typically, this inventive mobile telecommunication device can be realized by a cellular phone that provides the dedicated functionality for transmitting an access request and for receiving the temporary password from the service provider.

A conceivable, particularly low cost embodiment of the mobile telecommunication device can be implemented by making use of a commercially available cellular phone providing a programmable functionality. In this way, a specific software application can be installed on the existing cellular phone that allows for selecting a dedicated menu item on the cellular phone that is adapted for transmitting the access request to the service provider. In this way the inventive method of authentication can be universally realized from a user's point of view by installing an appropriate software application on his programmable cellular phone. Such software applications might be provided in form of Java applications or Java applets that may be supported by the telecommunication or service provider. This feature makes the inventive authentication scheme universally applicable to a wide range of users.

In another aspect, the invention provides an authentication server for generating a temporary password that is required by a user in order to authenticate to a network. The inventive authentication server comprises means for processing of an access request from the user, means for checking the access request on the basis of a user authentication database and means for generating the temporary password. Here, the access request is transmitted to the authentication server by the user making use of a mobile telecommunication device. The means for checking of the access request that is received by the authentication server are adapted to assert the access request if the user is authorized to access the network.

The user's authorization or authorization of several users to a variety of different networks is provided by the user authentication database. Furthermore, the means for generating the temporary password are particularly adapted to generate the temporary password only in response to an assertion of the access request. In this way, the authentication server provides checking of the access request, asserting the access request and when the service request has been asserted, to generate a corresponding temporary password. Typically, the authentication server is administered and provided by a telecommunication provider or by a similar provider in such a way, that the service of the authentication server is accessible from a mobile telecommunication device such as a cellular phone.

According to a further preferred embodiment of the invention, the user authentication database of the authentication server comprises authentication data of at least one user and at least one network. The authentication data stored in the user authentication database specifies which one of the at least one users is authorized to access any of the at least one networks.

In still another aspect, the invention provides a computer program product for a mobile telecommunication device for providing a temporary password to a user. This temporary password is required by the user in order to authenticate to a network, typically a VPN network. The computer program product comprises program means that are adapted to process an access request of the user, to transmit the access request to a service provider and to receive the temporary password from the service provider. Here, the temporary password is generated by the service provider in response to the assertion of the access request. Finally, the computer program product for the mobile telecommunication device comprises program means for providing the temporary password to the user. Alternatively, the computer program product for the mobile telecommunication device may further comprise program means for transmitting the received temporary password to the computing device that is dedicated to establish an IP-based connection to the network.

In still another aspect the invention provides a computer program product for an authentication server for generating a temporary password that is required by a user in order to authenticate to a network. The computer program product comprises program means that are adapted to process an access request from the user, to check the access request on the basis of a user authentication database and to generate the temporary password only in response to an assertion of the access request. The access request is asserted by making use of the user authentication database. In particular, the access request is asserted if the user is authorized to access the network. Additionally, the access request is transmitted to the authentication server by means of a mobile telecommunication device of the user.

### BRIEF DESCRIPTION OF THE DRAWINGS

In the following preferred embodiments of the invention will be described in greater detail by making reference to the drawings in which:

FIG. 1: shows a block diagram being illustrative of a first embodiment of the inventive authentication method,

FIG. 2: shows a block diagram illustrating a second embodiment of the invention incorporating a first and a second network,

FIG. 3: shows a block diagram schematically illustrating the internal structure of the service provider,

FIG. 4: schematically illustrates a basic embodiment of the user authentication database.

### DETAILED DESCRIPTION

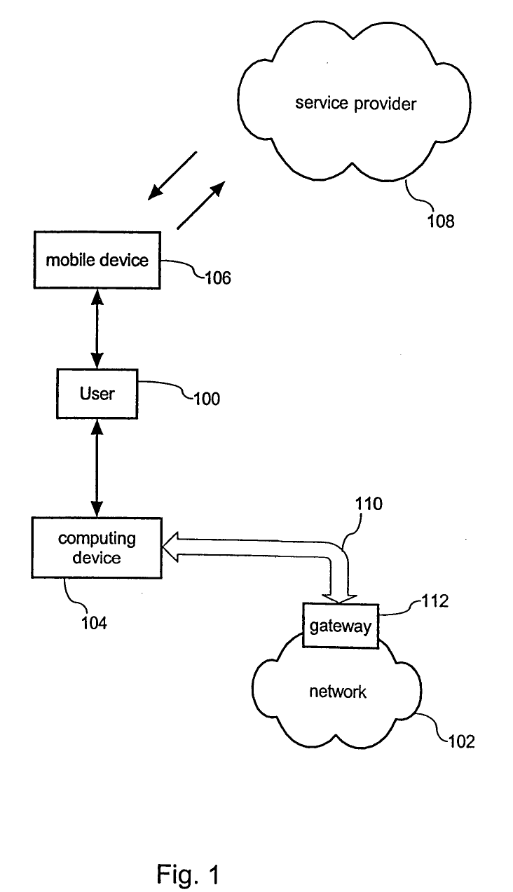

FIG. 1 schematically illustrates an environment or infrastructure for realizing the inventive authentication method. A user 100 wishes to access a network 102 via a computing device 104. The user 100 further has access to his personal mobile device 106 that is in turn adapted to communicate with the service provider 108. Accessing the network 102 requires authentication to the network 102. Authentication to the network 102 is typically performed by the network gateway 112.

Once the authentication is successfully performed, the connection 102 between the computing device 104 and the network 102 is established. Typically, the illustrated network 102 and the gateway 112 are implemented as VPN network and VPN gateway, respectively. Authentication to the network 102 requires entering of a one-time and/or temporary password into the computing device 104 during an authentication procedure.

This one-time and/or temporary password is generated and provided to the user 100 by the service provider 108 via the mobile device 106. Typically, the mobile device 106 is implemented as a cellular phone that allows for a bidirectional communication with the service provider 108. In order to obtain the temporary password from the service provider 108, the user 100 invokes an access request on the mobile device 106. This access request is then transmitted from the mobile device 106 to the service provider. The service provider 108 processes this received access request, asserts the access request, i.e. checks the user's authorization to access the network 102, generates the temporary password by making use of a dedicated cryptographic password generation scheme and transmits the generated one-time temporary password to the mobile device 106.

The mobile device 106 is further adapted to display the received temporary password to the user 100. The user 100 may then enter the provided password into the computing device 104 in order to authenticate to the network 102. In response to entering of the correct one-time temporary password into the computing device, the computing device 104 transmits a user identifier and the corresponding password to the gateway 112. In response to receive the correct combination of temporary password and user identifier, the user 100 is authenticated to access the network 102.

In this way, the mobile device 106 in combination with the service provider 108 effectively replaces a hardware implemented Token that is adapted to generate a network specific temporary password. Further, the user 100 does not have to carry along an additional hardware device that is merely adapted to generate temporary one-time passwords. The invention is based on the fact, that the mobile device 106 is a personal belonging of the user 100. By implementing the password requesting functionality into the mobile device 106, the mobile device 106 effectively takes over the functionality of a hardware Token as it is known in the prior art.

The connection 110 between the computing device 104 and the network 102 can in principle be implemented by any type of connection that provides data transmission between a computing device and a network. For example, the connection can be realized by a 56 Kbit modem based connection, an ISDN connection or a DSL connection. The connection may also be implemented as a wireless connection and might be based on e.g. WLan, IEEE 802.11 or other radio frequency (RF) or infrared (IR) based communication protocols.

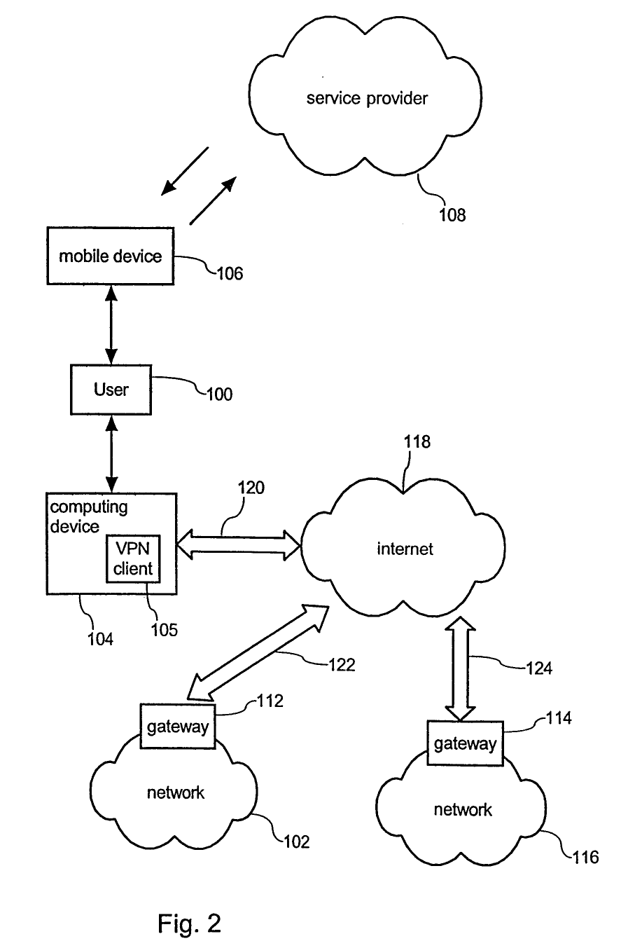

FIG. 2 schematically illustrates an Internet based embodiment of the inventive authentication procedure in a more detailed way. Also here the user 100 makes use of the computing device 104 and the mobile device 106 in order to access a network 102, 116. In contrast to the embodiment illustrated in FIG. 1 here, the user 100 may access one of a plurality of networks 102, 116 via the Internet 118. The computing device 104 is therefore adapted to establish a connection 120 to the Internet 118. Once being connected to the Internet 118, the user 100 may access anyone of the networks 102, 116 when appropriately authenticated.

In principle, the authentication procedure is performed in a similar way as described in FIG. 1. The user 100 invokes an access request for obtaining a temporary password for anyone of the networks 102, 116. Since the user 100 may authenticate to a plurality of networks 102, 116, the access request has to specify which one of the available networks 102, 116 the user wishes to access. As illustrated in FIG. 2 network 102 has gateway 112 and can be accessed via the Internet 118 by means of the connection 122. In a similar way network 116 has gateway 114. The network 116 is accessible via the Internet 118 by means of the connection 124. Preferably, both gateways 112, 114 are implemented as virtual private network gateways. Consequently, the computing device 104 comprises a VPN client 105 in order to enable authentication of the computing device 104 and hence to enable access to anyone of the networks 102, 116.

A user authentication database that is administered by the service provider 108 may specify which one of the networks 102, 116 is accessible by the user 100. For example, access to network 116 might be denied whereas access to network 102 might be admitted. In this case, when the user submits an access request to the service provider 108 by making use of his mobile phone 106, the user will only receive a temporary password when the access request specifies network 102. If the user 100 submits an access request to the service provider 108, thereby wishing to authenticate to network 116, the service provider has to deny an access to the network 116. Consequently, delivery of the one-time temporary password for accessing network 116 is disabled and the user 100 is not provided with the required password information.

By replacing a hardware Token by means of the mobile device 106 and the service provider 108 even a functionality of a plurality of network specific Tokens can be effectively merged into a personal device 106 of the user 100. In case the user has to access different VPNs with different authentication schemes, the user no longer has to carry along a network specific Token but may universally make use of his cellular phone in order to receive the appropriate temporary password.

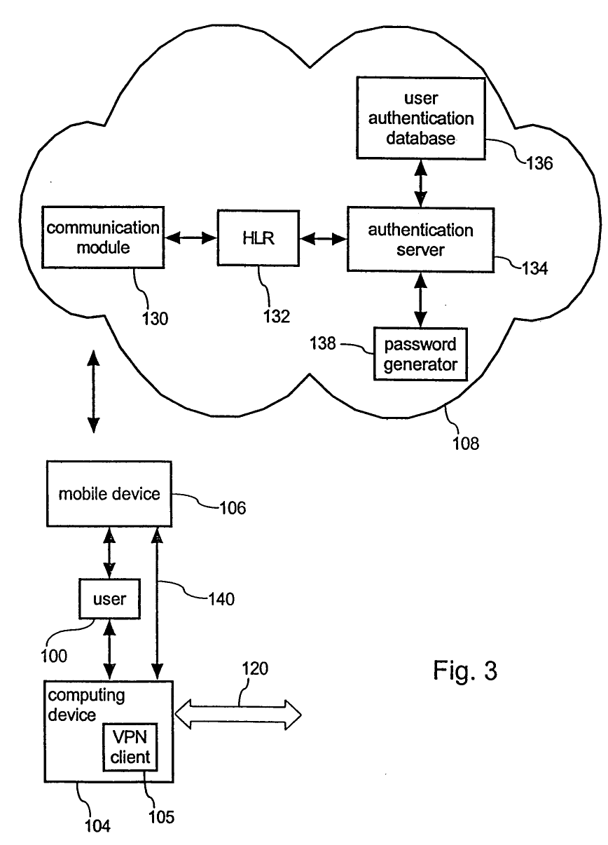

FIG. 3 schematically illustrates the internal structure of the service provider 108. In this embodiment, the service provider 108 also serves as a telecommunication provider. The service provider 108 has a communication module 130, a home location register (HLR) 132, an authentication server 134, a password generator 138 as well as a user authentication database 136. The communication module 130 provides signal processing for wireless data transmission. The communication module 130 may further provide wireless communication means in order to communicate with the mobile device 106.

The home location register 132 stores user related information for the wireless communication by means of the mobile device 106. Upon registering to the service provider 108, the user 100 may receive a SIM card with a specific identifier.

By means of the home location register 132 assignment between the user's contact information and the SIM card can be effectively performed. The user's contact information may refer to personal data of the user as well as address of the user and bank account details of the user. Moreover, the home location register 132 effectively provides authentication of the mobile device 106 to the mobile communication network provided by the telecommunication provider 108. Typically, the user 100 and his mobile device 106 authenticate to the services of the service provider 108 by entering a 4 digit PIN into the mobile device 106.

In a similar way, the authentication server 134 controls access of the user 100 to the user authentication database 136. In response to receive the access request from the mobile device 106, the authentication server 134 may first check whether the user 100 and the mobile device 106 are authorized to receive a temporary password from the service provider 108. This authentication procedure may be effectively realized by means of another, second static PIN. Whenever the user 100 submits a valid access request to the service provider, i.e. submitting the access request together with the appropriate static PIN, the authentication server 134 makes use of the user authentication database 136 in order to assert or to deny the access request of the user.

In particular, the user authentication database 136 is indicative, whether the user 100 is entitled to access the requested network. Once, an access request is asserted by the authentication server 134, the password generator 138 is invoked in order to generate an appropriate temporary one-time password. Generation of the password by means of the password generator 138 is based on cryptographic methods that are synchronized with matching cryptographic methods used by the VPN gateways of the networks 102, 116.

After generation of the temporary and/or one-time password, the generated password is transmitted to the authentication server 134 and is finally forwarded to the communication module 130. The communication module 130 further serves to transmit the generated password to the mobile device 106. Here, the received temporary password is either displayed to the user 100 or it might be directly transmitted to the computing device 104 via the connection 140. The connection 140 may be based on a fixed connection or on a wireless connection making use of e.g. infrared or radio frequency communication techniques.

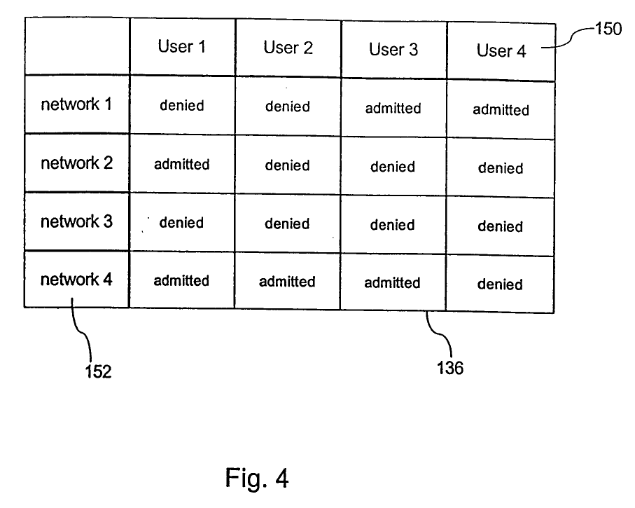

FIG. 4 schematically illustrates a basis embodiment of the user authentication database 136. Here, the user authentication database 136 is adapted to provide authorization information for several users and several different networks. Therefore, the user authentication database 136 is arranged as a two dimensional matrix, where the users are arranged in a horizontal user array 150 and the networks are arranged in a vertical network array 152. The single fields of the matrix like user authentication database 136 now specify which user is authorized to use which type of network. For example, user 1 has access to network 2 and network 4 but is not allowed to access network 1 and network 3.

FIG. 4 gives only a basic example of how to implement the user authentication database. The database 136 is by now means restricted to a two dimensional array. Moreover, additional parameter like individual access rights might be incorporated leading to a multidimensional representation of the user authentication database.

1. A method of authenticating a user to a network, the user making use of a computing device being adapted to establish an IP-based connection to the network, wherein authentication to the network requires entering at least a user identification and a temporary password, the method of authenticating the user comprising the steps of:
requesting the temporary password from a service provider by transmitting an access request to the service provider, the access request being transmitted by means of a mobile telecommunication device,
checking the access request on the basis of a user authentication database and asserting the access request if the user is authorized to access the network,
generating the temporary password in response to an assertion of the access request,
transmitting the temporary password from the service provider to the mobile telecommunication device.

2. The method according to claim 1, wherein requesting of the temporary password from the service provider further comprises authenticating the user to the service provider.

3. The method according to claim 1, wherein the access request comprises at least a network identifier and an identifier of the mobile telecommunication device being indicative of the user's identity.

4. The method according to claim 1, further comprising transferring the temporary password from the mobile telecommunication device to the computing device on the basis of a communication interface.

5. The method according to claim 1, wherein the network is an IP-based virtual private network (abbreviated VPN), the network comprising a VPN gateway and the computing device comprising a VPN client.

6. A mobile telecommunication device for providing a temporary password to a user, the temporary password being required by the user in order to authenticate to a network, the mobile telecommunication device comprising:
means for transmitting an access request to a service provider,
means for receiving the temporary password from the service provider, the temporary password being generated by the service provider in response to an assertion of the access request,
means for providing the temporary password to the user.

7. An authentication server for generating a temporary password required by a user in order to authenticate to a network, the authentication server comprising:
means for processing of an access request from the user, the access request being transmitted to the authentication server by the user making use of a mobile telecommunication device,
means for checking the access request on the basis of a user authentication database, the means for checking being further adapted to assert the access request if the user is authorized to access the network,
means for generating the temporary password, said means being adapted to generate the temporary password only in response to an assertion of the access request.

8. The authentication server according to claim 7, wherein the user authentication database comprises authentication data of at least one user and at least one network, the authentication data specifying which user of the at least one user is authorized to access any of the at least one network.

9. A computer program product for a mobile telecommunication device for providing a temporary password to a user, the temporary password being required by the user in order to authenticate to a network, the computer program product comprising program means being adapted to:
process an access request of the user,
transmit the access request to a service provider,
receive the temporary password from the service provider, the temporary password being generated by the service provider in response to the assertion of the access request,
provide the temporary password to the user.

10. A computer program product for an authentication server for generating a temporary password required by a user in order to authenticate to a network, the computer program product comprising program means being adapted to:
processing of an access request from the user, the access request being transmitted to the authentication server by the user making use of a mobile telecommunication device,
checking the access request on the basis of a user authentication database, checking of the access request comprising asserting the access request if the user is authorized to access the network,
generating the temporary password only in response to the assertion of the access request.
